(19) United States
(12) Patent Application Publication
(10) Pub. No.: US 2014/0143858 A1
(43) Pub. Date: May 22, 2014

(54) PROCESSING ARRANGEMENT AND A METHOD FOR PROCESSING INFORMATION IN A MACHINE-TO-HUMAN COMMUNICATIONS INTERFACE

(71) Applicant: INFINEON TECHNOLOGIES AG, Neubiberg (DE)

(72) Inventor: Olaf Brixel, Ruhmannsfelden (DE)

(73) Assignee: Infineon Technologies AG, Neubiberg (DE)

(21) Appl. No.: 13/678,569

(22) Filed: Nov. 16, 2012

(51) Int. Cl. G06F 21/36

(52) U.S. Cl. CPC G06F 21/36
USPC 726/19

(57) ABSTRACT

A processing arrangement in accordance with various embodiments may include: a security element configured to generate a digital image; a display device configured to receive the digital image from the chip card, and to display the digital image; and an input device configured to receive a user input, wherein the user input identifies a part of the digital image, and wherein the input device is further configured to provide the chip card with information indicating which part of the digital image is identified by the user input.

### TECHNICAL FIELD

Various embodiments relate to a processing arrangement and a method for processing information in a machine-to-human communications interface.

### BACKGROUND

A machine-to-human communications interface may include a hardware device, which may be configured to display authentic information (e.g. an account balance) from a security element (e.g. an embedded security element, such as, for example, a chip card embedded in a cash card). In addition to displaying authentic information from the security element, the hardware device may be configured to allow information (e.g. user PIN, account password, account login name) to be entered by a human user into the security element (e.g. chip card).

The hardware device may be a secure device, but may be running a software program that may not be secure. For example, the secure hardware device may be running a software program that may record information entered into the security element by means of, for example, a spying method, such as, for example, a key logger. In another example, the secure hardware device may be connected to an unsecured, but computationally powerful computer. In either case, information entered into the security element may be compromized. In some cases, there may be no possibility to use a secured hardware device, for example, when using a security element (e.g. chip card) with a mobile device (e.g. smart phones). Accordingly, a more secure machine-to-human communications interface may be desirable.

### SUMMARY

A processing arrangement in accordance with various embodiments may include: a security element configured to generate a digital image; a display device configured to receive the digital image from the chip card, and to display the digital image; and an input device configured to receive a user input, wherein the user input identifies at least one part of the digital image, and wherein the input device is further configured to provide the chip card with information indicating which part of the digital image is identified by the user input.

A method for processing information in a machine-to-human communications interface in accordance with various embodiments may include: generating a digital image; displaying the digital image; identifying at least one part of the digital image; and providing information indicating which part of the digital image is identified.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a machine-to-human communications interface.

FIG. 2 shows a processing arrangement according to one or more embodiments.

FIG. 3 shows a digital image generated by a chip card according to one or more embodiments.

FIG. 4 shows a method for processing information in a machine-to-human communications interface.

### DESCRIPTION

The following detailed description refers to the accompanying drawings that show, by way of illustration, specific details and embodiments in which the invention may be practised. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

The word “exemplary” is used herein to mean “serving as an example, instance, or illustration”. Any embodiment or design described herein as “exemplary” is not necessarily to be construed as preferred or advantageous over other embodiments or designs.

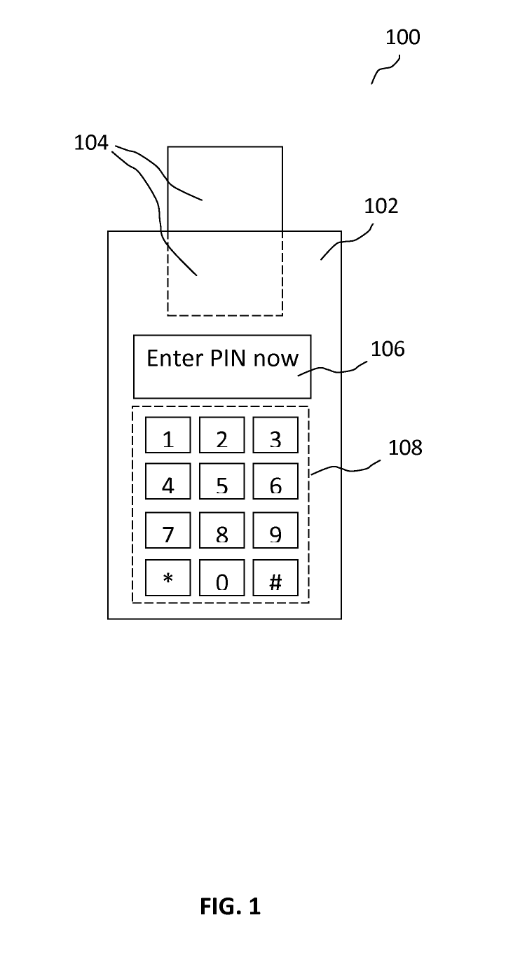

FIG. 1 shows a machine-to-human communications interface 100.

The machine-to-human communications interface 100 may include a hardware device 102 and a security element 104, which may be inserted into the hardware device 102, as shown in FIG. 1.

The hardware device 102 may include, or may be, a security evaluated (namely, secured) card reader. The hardware device 102 may include a display 106 and a pinpad 108. The hardware device 102 may be configured to display authentic information from the security element 104 (e.g. chip card) by means of, for example, the display 106. The hardware device 102 may also be configured to allow information from a human user (e.g. user PIN, account password, account login name) to be entered into the security element 104 (e.g chip card) by means of, for example, the pinpad 108.

The hardware device 102 may be connected to a regular, powerful but untrustworthy computer and/or may be running a software program that may not be secure. Accordingly, information entered into the security device 104 and/or authentic information from the security device 104 may be known to a third party, namely, someone other than the human user of the hardware device 102.

In another scenario, the hardware device 102 may be a low cost device without the display 106 and/or the key pad 108. In such a case, the hardware device 102 may be used with a secure chip card as an authentication device. For example, a possibly unsecured home PC may be used to enter information (e.g. user PIN, account password, account login name) to the security element 104 (e.g. chip card) or to the hardware device 102. As with the above-mentioned case, information entered into the security element 104 may be compromized.

Various embodiments may provide a processing arrangement that may prevent or substantially reduce the provision of authentic information from a security element and/or information entered into a security element to a third party. Hereinafter, the terms “security element” and “chip card” may refer to the same logical entity and may be used interchangeably.

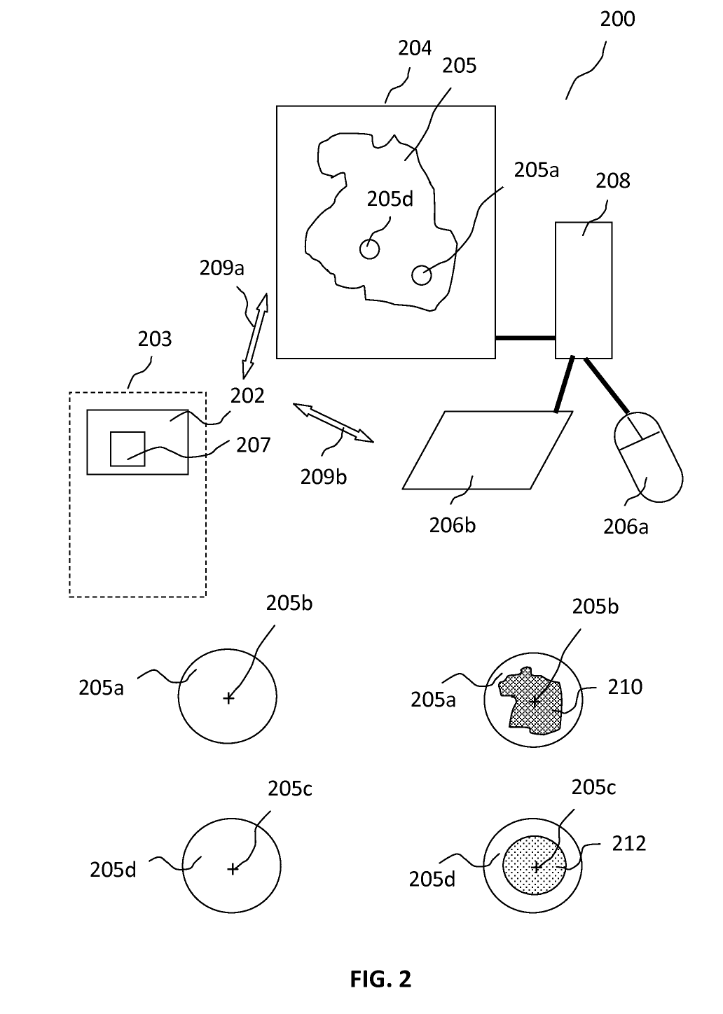

FIG. 2 shows a processing arrangement 200 according to one or more embodiments.

The processing arrangement 200 may include a chip card 202, a display device 204, and an input device 206a, 206b. The processing arrangement 200 may further include a chip card compatible device 203.

An aspect of the processing arrangement 200 may be summarized as follows: the chip card 202 may be configured to generate a digital image 205. The digital image 205 may be generated such that it may be recognized by a human user, and not by a machine. At least one part 205a, 205d of the digital image 205 may be selected and/or identified by a user input, and information indicating which part of the digital image is identified by the user input may be provided to the chip card 202. The chip card 202 may be configured to process the information indicating which part of the digital image is identified by the user input to produce at least one alphanumeric character, which may be known to the chip card 202 alone. Details of the processing arrangement 200 are presented in the following description.

In one or more embodiments, the chip card 202 may include, or may be, at least one of a smart card, a SIM card, or an integrated circuit card (ICC), although other embodiments of a chip card 202 suitable for use in a machine-to-human communications interface may be possible. In one or more embodiments, the chip card 202 may be included in (namely, a part of) the chip card compatible device 203, such as, for example, a smart phone, a smart card reader, a NFC (Near Field Communication) enabled credit card, an electronic ticket smart card, etc.

In one or more embodiments, the chip card 202 may be configured to generate a digital image 205. In one or more embodiments, the digital image 205 may be suitable for use in a machine-to-human communications interface. By way of an example, the digital image 205 may, for example, be generated such that it may be recognized (e.g. visually recognized) or processed by a human (e.g. processed by touch and/or selection), and not by a machine or a computer implemented program (e.g. a computer, a software installed on a computer, for example, a key-logger configured to record alphanumeric characters entered into a computer, etc.).

In one or more embodiments, the digital image 205 may be suitable for a challenge-response test suitable for use in a machine-to-human communications interface (e.g. a CAPTCHA). In one or more embodiments, the digital image 205 generated by the chip card 202 may be encoded according to any one of the JPEG (Joint Photographic Experts Group), PNG (Portable Network Graphics), GIF (Graphics Interchange Format), TIFF (Tagged Image File Format), BMP (BitMaP) formats, although other commonly used digital image formats may be possible.

In one or more embodiments, the chip card 202 may be configured to generate the digital image 205 using at least one pre-stored digital image. The at least one pre-stored digital image may be known to the chip card 202 alone, and not to any one of the chip card compatible device 203, the display device 204, any hardware and/or software connected to or installed in the display device 204, the input device 206a 206b, or any other hardware device or software implementation other than the chip card 202.

The at least one pre-stored digital image may be provided by a user (e.g. a human user of the chip card 202 and/or the chip card compatible device 203). The at least one pre-stored digital image may be an image (e.g. a picture) that may be familiar to or selected by the user. For example, the at least one pre-stored digital image may be a digital picture taken by the user, a digital picture of the user, a digital picture of the user's family, a digital design, or any picture known to the user. Accordingly, the digital image 205, generated using the at least one pre-stored digital image, may be recognized by the user as originating from the user's chip card 202.

In one or more embodiments, the at least one pre-stored digital image may be stored in an image database and/or an image lookup table. The image database and/or image lookup table may be stored in the chip card 202. The image database and/or the image lookup table may be known to the chip card 202 alone, and not to any one of the chip card compatible device 203, the display device 204, any hardware and/or software connected to or installed in the display device 204, the input device 206a 206b, or any other hardware device or software implementation other than the chip card 202.

In one or more embodiments, the chip card 202 may be configured to generate the digital image 205 using at least one image generation algorithm. The at least one image generation algorithm may include a conformal mapping, a bilinear transformation, a non-linear transformation, a linear transformation (e.g. a rotation, a translation, etc.), although other image generation algorithms may be possible.

The at least one image generation algorithm may be performed on the at least one digital pre-stored image described above. Alternatively, the at least one image generation algorithm may be executed by the chip card 202 on the fly. For example, a random number and/or random vector may be generated by the chip card 202, and the at least one image generation algorithm may accept the random number and/or random vector as an input, and may generate the digital image 205 as an output.

The at least one image generation algorithm may be known to the chip card 202 alone, and not by any one of the chip card compatible device 203, the display device 204, any hardware and/or software connected to or installed in the display device 204, the input device 206a 206b, or any other hardware device or software implementation other than the chip card 202.

In one or more embodiments, the at least one image generation algorithm may be executed on the chip card 202 alone, and not on the chip card compatible device 203, the display device 204, the input device 206a 206b, any hardware and/or software connected to or installed in the display device 204, or any other hardware device or software implementation other than the chip card 202.

In one or more embodiments, the at least one image generation algorithm may be stored in an algorithm database and/or an algorithm lookup table. The algorithm database and/or algorithm lookup table may be stored in the chip card 202. The algorithm database and/or algorithm lookup table may be known to the chip card 202 alone, and not by any one of the chip card compatible device 203, the display device 204, any hardware and/or software connected to or installed in the display device 204, the input device 206a 206b, or any other hardware device or software implementation other than the chip card 202.

In one or more embodiments, the chip card 202 may, optionally, include a memory 207. The memory 207 may be configured to store at least one of the image lookup table, the image database, the at least one pre-stored digital image, the algorithm lookup table, the algorithm database, and the at least one image generation algorithm.

In summary, the chip card 202 may be configured to generate the digital image 205 by using, for example, at least one of the following: the at least one pre-stored digital image and the at least one image generation algorithm. The at least one pre-stored digital image and/or the at least one image generation algorithm may be known to the chip card 202 alone, and not by any one of the chip card compatible device 203, the display device 204, any hardware and/or software connected to or installed in the display device 204, the input device 206a 206b, or any other hardware device or software implementation other than the chip card 202. Further, generation of the digital image 205 may be executed on the chip card 202 alone, and not by any hardware device or software implementation other than the chip card 202.

The processing arrangement 200 may include the display device 204. The display device 204 may be configured to display the digital image 205 generated by the chip card 202.

In one or more embodiments, the display device 204 may include, or may be, at least one of a computer screen of a personal computer, an LCD screen, a projection screen, a touch screen display (e.g. a touch screen display of a mobile telephone, a computer or any mobile computing device), although other display devices may be possible as well.

The display device 204 may be configured to receive the digital image 205 from the chip card 202. Accordingly, the chip card 202 may be configured to provide the digital image 205 to the display device 204. In one or more embodiments, the chip card 202 may be communicatively coupled 209a to the display device 204 in order to provide the digital image 205 to the display device 204.

In one or more embodiments, the display device 204 may be separate from the chip card compatible device 203 (as shown in FIG. 2). Accordingly, the communicative coupling 209a between the display device 204 and the chip card 202 may be by means of a wireless communications channel (e.g. Bluetooth, GSM (Global System for Mobile Communications), UMTS (Universal Mobile Telecommunications System), NFC, etc.).

In one or more embodiments, the display device 204 may be part of the chip card compatible device 203. For example, the display device 204 may be a display of a smartphone, a display of a card reader, a display of a computer (not shown in FIG. 2). In such an embodiment, the communicative coupling 209a between the display device 204 and the chip card 202 may be by means of a hardwired connection between the display device 204 and the chip card 202.

Whilst there may be a communicative link 209a between the display device 204 and the chip card 202, the contents of the chip card 202 (e.g. the at least one pre-stored digital image and/or the at least one image generation algorithm) may be known only to the chip card 202, and not to the display device 204, or a hardware device 208 that the display device 204 may be connected to or may be a part of.

The processing arrangement 200 may include the input device 206a, 206b. The input device 206a, 206b may include, or may be, any device that may be suitable for identifying and/or selecting at least one part 205a, 205d of the digital image 205. Stated differently, the input device 206a, 206b may be configured to allow a user to directly select and/or identify and/or interact with the digital image 205. The input device 206a, 206b may be configured to receive a user input. The user input may identify and/or select the at least one part 205a, 205d of the digital image 205. By way of an example, a computer mouse may be the input device 206a, 206b, which may identify and/or select the at least one part 205a, 205b of the digital image 205 by means of a computer mouse click as the user input. By way of another example, a touch screen display may be the input device 206a, 206b, which may identify and/or select the at least one part 205a, 205d of the digital image 205 by means of a touch screen input as the user input. By way of a counter-example, a computer keyboard and/or pin pad of a card reader may not be suitable as the input device 206a, 206b since the computer keyboard and/or pin pad may not be configured to allow the user to directly select and/or identify and/or interact with the digital image 205.

In one or more embodiments, the input device 206a, 206b (e.g. a computer mouse, a touch screen display, etc.) may be configured to provide the chip card 202 with information indicating which part of the digital image 205 is identified and/or selected by the input device 206a, 206b. In one or more embodiments, the input device 206a, 206b may be configured to provide the chip card 202 with information about a time at which the at least one part 205a, 205d of the digital image 205 is identified and/or selected by the input device 206a, 206b. For example, the input device 206a, 206b may include, or may be, a computer mouse, and the computer mouse may be configured to provide the chip card 202 with a click sequence of the computer mouse.

The input device 206a, 206b may be configured to provide the chip card 202 with information indicating which part of the digital image 205 is identified and/or selected by the input device 206a, 206b by means of a communicative link 209b between the input device 206a, 206b and the chip card 202. The communicative link 209b between the input device 206a, 206b may include, or may be, a wireless communications channel (e.g. Bluetooth, GSM, UMTS, NFC, etc.) or a hardwired connection between the input device 206a, 206b and the chip card 202.

Whilst there may be a communicative link 209b between the input device 206a, 206b and the chip card 202, the contents of the chip card 202 (e.g. the at least one pre-stored digital image and/or the at least one image generation algorithm) may be known only to the chip card 202, and not to the input device 206a 206b, or a hardware device 208 that the input device 206a 206b may be connected to or may be a part of.

In one or more embodiments, the information indicating which part of the digital image 205 is identified and/or selected by the input device 206a, 206b may include the spatial coordinates of the at least one part 205a, 205d of the digital image 205 identified and/or selected by the input device 206a, 206b. In other words, the information indicating which part of the digital image 205 is identified and/or selected by the input device 206a, 206b may include, or may be, selection coordinates 205b, 205c. By way of an example, the input device 206a, 206b may select (e.g. by means of a mouse click) the selection coordinate (e.g. a point) 205b when identifying and/or selecting the part 205a of the digital image 205. Accordingly, information indicating which part of the digital image 205 is identified and/or selected by the input device 206a, 206b may include, or may be, the selection coordinates 205b of the part 205a of the digital image 205. By way of another example, the input device 206a, 206b may select (e.g. by means of a mouse click) the selection coordinate (e.g. a point) 205c when identifying and/or selecting the part 205d of the digital image 205. Accordingly, information indicating which part of the digital image 205 is identified and/or selected by the input device 206a, 206b may include, or may be, the selection coordinates 205c of the part 205d of the digital image 205.

In one or more embodiments, the information indicating which part of the digital image 205 is identified and/or selected by the input device 206a, 206b may include, or may be, a digital image of a region 210, 212 surrounding the selection coordinates 205b, 205c. As described above, the digital image 205 generated by the chip card 202 may be encoded according to any one of the JPEG, PNG, GIF, TIFF, BMP formats, or other digital image formats. Accordingly, the digital image of the region 210, 212 surrounding the selection coordinates 205b, 205c may also be encoded according to any one of the JPEG, PNG, GIF, TIFF, BMP formats, or other digital image formats.

In one or more embodiments, the chip card 202 may be further configured to map the information indicating which part of the digital image 205 is identified and/or selected by the input device 206a 206b to information indicating what is selected and/or identified by the user input. For example, information indicating which part of the digital image 205 is identified may be mapped to at least one alphanumeric character.

In one or more embodiments, mapping the information indicating which part of the digital image 205 is identified and/or selected by the input device 206a, 206b to the at least one alphanumeric character may be performed using a mapping algorithm. In one or more embodiments, the mapping algorithm may be executed on the chip card 202. The mapping algorithm may be known to the chip card 202 alone, and not to any one of the chip card compatible device 203, the display device 204, a hardware and/or software connected to or installed in the display device 204, the input device 206a 206b, or any other hardware device or software implementation other than the chip card 202.

As described above, information indicating which part of the digital image 205 is identified and/or selected by the input device 206a, 206b may include the selection coordinates 205b, 205c. Accordingly, the mapping algorithm executed on the chip card 202 may use the selection coordinates 205b, 205c as an input parameter, and may produce the at least one alphanumeric character as the output. For example, the mapping algorithm may map the selection coordinates 205b of the part 205a of the digital image 205 to an alphanumeric character. Additionally, the mapping algorithm may map the selection coordinates 205c of the part 205d of the digital image 205 to the same or to another alphanumeric character. The at least one alphanumeric character may be represented as a US ASCII code, a ISO 8859-1 code, a CP 037 and/or CP 500 code (and its variants), a Windows CP 1252 code, a Shift-JIS code, a UTF code (e.g. UTF-8, UTF-16, UTF-32, its variants, etc.), or any other alphanumeric character encoding that may be suitable for reading by a machine or a software implementation executed on a machine.

As described above, information indicating which part of the digital image 205 is identified and/or selected by the input device 206a, 206b may include a digital image of a region 210, 212 surrounding selection coordinates 205b, 205c. In one or more embodiments, the mapping algorithm executed on the chip card 202 may use the digital image of a region 210, 212 surrounding the selection coordinates 205b, 205c as an input parameter, and may produce the at least one alphanumeric character as the output. The mapping algorithm may be able to produce at least one alphanumeric character as the output by means of a pattern recognition algorithm, or any other algorithm that may be suitable for mapping a digital image of a region 210, 212 surrounding the selection coordinates 205b, 205c to at least one alphanumeric character.

An effect of the processing arrangement 200 may be that the chip card 202 may be configured to generate the digital image 205, and that generating the digital image 205 may be performed by the chip card 202 alone, and not by any one of the chip card compatible device 203, the display device 204, a hardware and/or software connected to or installed in the display device 204, the input device 206a 206b, or any other hardware device or software implementation other than the chip card 202. Accordingly, an effect of the above may be a more secure human-to-machine communications interface.

An effect of the processing arrangement 200 may be that the chip card 202 may be configured to process information indicating which part of the digital image 205 is identified and/or selected by the input device 206a 206b (e.g. mapping to at least one alphanumeric character). The processing may be performed by the chip card 202 alone, and not by any one of the chip card compatible device 203, the display device 204, a hardware and/or software connected to or installed in the display device 204, the input device 206a 206b, or any other hardware device or software implementation other than the chip card 202. Accordingly, an effect of the above may be a more secure human-to-machine communications interface.

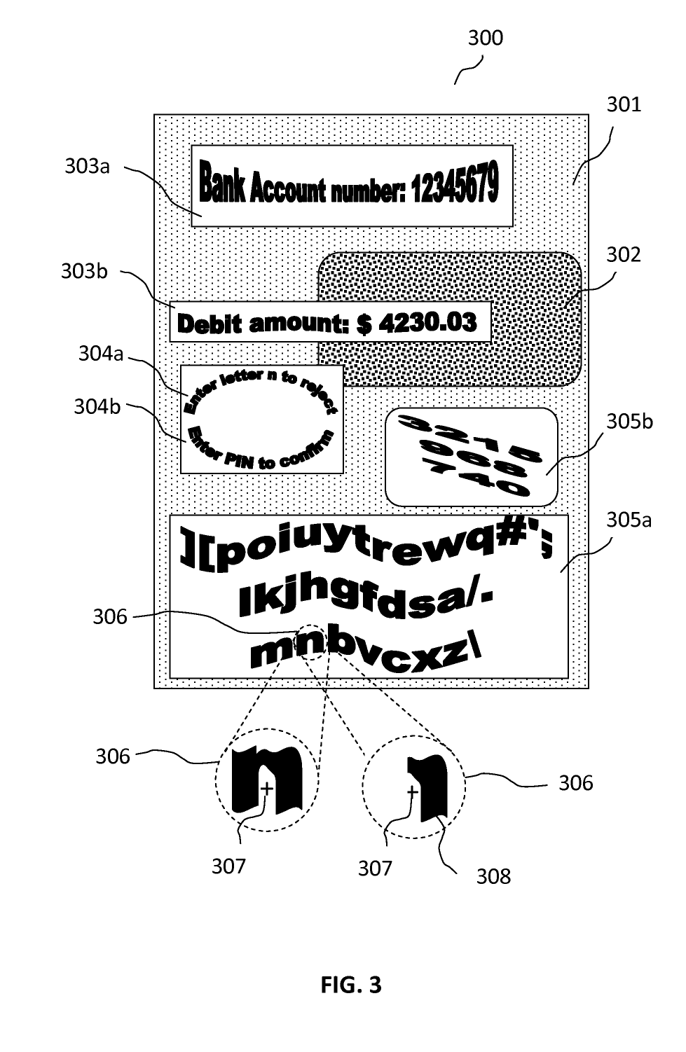

FIG. 3 shows a digital image 300 generated by a chip card 202 according to one or more embodiments.

An aspect of the digital image 300 may be summarized as follows: The digital image 300 may be generated using at least one digital image 301, 302 stored in the chip card 202. The digital image 300 may include at least one region 303a, 303b that may show (namely, display) authentic information to be confirmed by a user. The digital image 300 may include at least one region 304a, 304b that may show a request for a response and/or a request for information from the user. The digital image 300 may include at least one part or region 305a, 305b that may be suitable for identification and/or selection by the input device 206a, 206b described above in relation to FIG. 2. Details of the digital image 300 are presented in the following description.

In one or more embodiments, the digital image 300 may include at least one region 303a, 303b that may show authentic information to be confirmed by the user. In one or more embodiments, the authentic information may be information provided by the chip card 202. The authentic information to be confirmed by the user may include, or may be, at least one of an amount of a financial transaction (e.g. an amount to be paid by the user, a bank transfer amount, etc), a destination and/or an origin of the financial transaction (e.g. a bank account to credit for the purchase of a good or a service, a bank account to debit for payment of a purchase, etc.), a request for a confirmation of the financial transaction (e.g. a confirmation to proceed with a purchase, a confirmation to proceed with a bank transfer, a confirmation to proceed with an account debit, etc.).

In one or more embodiments, the at least one region 303a, 303b may display or show the authentic information to be confirmed by the user in a disguised manner. By way of an example, the text of the authentic information to be confirmed by the user may be optically disguised (e.g. by a CAPTCHA) and/or distorted in such manner that the authentic information to be confirmed may be read with ease by the user, and may not be recognized or processed by a machine or by a software implementation running on a machine.

In one or more embodiments, the digital image 300 may include at least one region 304a, 304b that may show a request for a response from the user and/or a request for information from the user. The information requested from the user may include a request for the user's transaction PIN (Personal Identification Number) and/or TAN (Transaction Authentication Number), a request for the user's account password and/or account login name, a request to confirm or reject a transaction, although other types of information may be requested from the user.

In one or more embodiments, the at least one region 304a, 304b that may display or show the request for information from the user in a disguised manner. By way of an example, the text of the request for information may be optically disguised (e.g. by a CAPTCHA) and/or distorted in such manner that the request for information may be read with ease by the user, and may not be recognized or processed by a machine or by a software implementation running on a machine.

In one or more embodiments, the digital image 300 may include at least one part 305a, 305b that may be suitable for identification and/or selection by the input device 206a 206b shown in FIG. 2. The at least one part 305a, 305b may be configured to receive a user input in response to the authentic information to be confirmed by the user (e.g. amount of a financial transaction, origin or destination of a financial transaction, etc.) and/or the request for a response from the user and/or a request for information from the user (e.g. a request for a user PIN, an account password, an account login name, etc.).

In one or more embodiments, the at least one part 305a, 305b of the digital image 300 may include a digital image of an alphabet keypad 305a and/or a digital image of a numeric keypad 305b. Hereafter, the word “keypad” may be used to denote at least one of the numeric keypad 305b and the alphabet keypad 305a.

In one or more embodiments, the digital image of the keypad 305a may include a distorted digital image of a keypad 305a. The distorted digital image of the keypad 305a may show glyphs 306 and/or an alphanumeric layout that may be different from a keypad that the user may be accustomed to (e.g. the user in the US or the United Kingdom accustomed to a QWERTY keyboard, the user in Germany accustomed to a QWERTZ keyboard, or any other keyboard of a particular country that the user may be accustomed to).

In one or more embodiments, the distortion of the image of the at least one part 305a, 305b that may be suitable for identification and/or selection by the input device 206a, 206b may be performed by a distorting algorithm. In one or more embodiments, the distorting algorithm may be executed on the chip card 202 shown in FIG. 2. The distorting algorithm may be known to the chip card 202 alone, and not by any one of the chip card compatible device 203, the display device 204, any hardware and/or software connected to or installed in the display device 204, the input device 206a 206b, or any other hardware device or software implementation other than the chip card 202. An effect of the above may be that the distortion of the at least one part 305a, 305b that may be suitable for identification and/or selection by a user input may be known to chip card 202 alone.

In one or more embodiments, the layout of alphanumeric characters (namely, letters of an alphabet and/or numerals) within the at least one region 305a, 305b may be sorted using a randomizing algorithm The randomizing algorithm may be executed on the chip card 202. For example, the chip card 202 may generate a random number and/or random vector, and may arrange the layout of alphanumeric characters based on the result of the generated random number and/or random vector. The randomizing algorithm may be known to the chip card 202 alone, and not by any one of the chip card compatible device 203, the display device 204, any hardware and/or software connected to or installed in the display device 204, the input device 206a 206b, or any other hardware device or software implementation other than the chip card 202. An effect of the above may be that the layout of the at least one part 305a, 305b that may be suitable for identification and/or selection by a user input may be known to chip card 202 alone.

As described above in relation to FIG. 2, the processing arrangement 200 may include the input device 206a, 206b suitable for selecting and/or identifying the at least one part 205a, 205d of the digital image 205 in FIG. 2. The at least one part 205a, 205d of the digital image 205 shown in FIG. 2 may correspond to at least a portion of the at least one part 305a, 305b of the digital image 300 shown in FIG. 3. For example, the at least one part 205a, 205d of the digital image 205 selected and/or identified by the input device 206a, 206b may correspond to a portion 306 of the distorted digital image of the keypad 305a, such as, for example the portion displaying a letter “n” of the distorted digital image of the keypad 305a.

As described above in relation to FIG. 2, the information indicating which part 205a, 205d of the digital image 205 is identified and/or selected by the input device 206a, 206b may include the selection coordinates 205b, 205c. In one or more embodiments, the selection coordinates 205b, 205c shown in FIG. 2 may correspond to a selection coordinate 307 of the portion 306 of the distorted digital image of a keypad 305a selected and/or identified by the input device 206a, 206b.

As described above in relation to FIG. 2, the information indicating which part 205a, 205d of the digital image 205 is identified and/or selected by the input device 206a, 206b may include a digital image of the region 210, 212 surrounding the center selection coordinates 205b, 205c. In one or more embodiments, the region 210, 212 surrounding the selection coordinates 205b, 205c shown in FIG. 2, may correspond to a region 308 surrounding the selection coordinate 307. For example, the digital image of the region 308 surrounding the selection coordinate 307 may be a digital image of at least a part of a letter and/or number selected by the input device 206a, 206b (as shown in FIG. 3).

As described above in relation to FIG. 2, the chip card 202 may be further configured to map the information indicating which part 205a, 205d of the digital image 205 is identified and/or selected by the input device 206a 206b to at least one alphanumeric character. Accordingly, the chip card 202 may be configured to map the selection coordinates 307 to at least one alphanumeric character. In like manner, the chip card 202 may be configured to map the digital image of the region 308 surrounding the selection coordinate 307 to at least one alphanumeric character.

Accordingly, an effect of the above may be that the chip card 202 alone generates the digital image 300 and/or processes information indicating which part of the digital image 300 is identified and/or selected by the input device, and not any one of the chip card compatible device 203, the display device 204, a hardware and/or software connected to or installed in the display device 204, the input device 206a 206b, or any other hardware device or software implementation other than the chip card 202. Accordingly, an effect of the above may be a more secure human-to-machine communications interface.

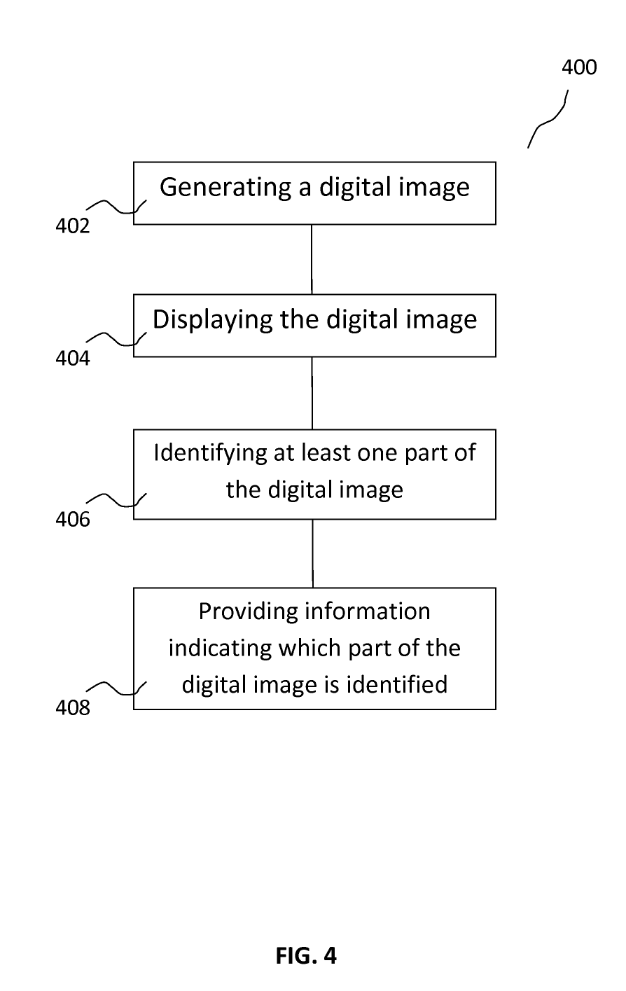

FIG. 4 shows a method 400 for processing information in a machine-to-human communications interface.

The method 400 may include generating a digital image (in 402), displaying the digital image (in 404), identifying (and/or selecting) at least one part of the digital image (in 406), and providing information indicating which part of the digital image is identified (and/or selected) (in 408).

The method 400 may include generating a digital image (in 402). The digital image may be generated using at least one of the above-described distorting algorithm, randomizing algorithm, at least one pre-stored digital image, image database, image lookup table, image generation algorithm, the algorithm database, and the algorithm look up table. The further features described above in respect of generating the digital image 205 using the chip card 202 may be equally applicable to generating the digital image (in 404).

The method 400 may include displaying the digital image (in 404). The digital image may be displayed using the display device 204 described above. The further features described above in respect of displaying the digital image 205 using the display device 204 may be equally applicable to displaying the digital image (in 404).

The method 400 may include identifying (and/or selecting) at least one part of the digital image (in 406). The at least one part of the digital image may be identified and/or selected using the input device 206a, 206b described above. The further features described above in respect of identifying (and/or selecting) at least one part of the digital image 205 may be equally applicable to identifying (and/or selecting) at least one part of the digital image (in 406).

The method 400 may include providing information indicating which part of the digital image is identified (and/or selected) (in 408). Information indicating which part of the digital image is identified (and/or selected) may be provided by the input device 206a 206b to the chip card 202, as described above. The further features described above in respect of providing information indicating which part of the digital image 205 is identified (and/or selected) may be equally applicable to providing information indicating which part of the digital image is identified (and/or selected) (in 408).

While machine-to-machine communication may be protected by using strong cryptographic measures, the machine-to-human communication interface may rely on the security of the human interface device.

The use of chip cards (e.g. smart cards, SIM cards, NFC enables credit cards, etc.) may require expensive security evaluated card reader devices providing display and key board in a secured module. Display of information from the smart card may be followed by the entering if secret information like PIN to the smart card. The card reader may be connected to a regular, powerful but not trustworthy PC. In the case of using smart cards with mobile devices like smart phones, there may be no possibility to use a trusted reader. Accordingly, secret information entered to the smart card reader may be compromized or unsecured as spying methods may be based on interpreting recorded input signals (e.g. key logger).

According to various embodiments, the machine-to-human communications interface may be protected without the need of extra hardware and without big challenges for a human user.

According to various embodiments, a regular computer or smart phone or card reader may be used as display and input device for smart cards without disclosing secret information to an unsecure hardware or software environment.

According to various embodiments, a complete virtual key pad and graphically disguised output may be created as a digital image in the smart card and transferred to a possibly unprotected hardware or software environment.

According to various embodiments, the unsecured hardware or software environment may be used as display device only.

According to various embodiments, a click or touch operation may be performed on a random sorted and optical disguised key pad.

According to various embodiments, the human user may read a confidential message from the smart card, e.g. amount and destination of a financial transaction, from a disguised graphic and may confirm the transaction by clicking on a virtual graphically disguised and randomly sorted key pad.

According to various embodiments, the data transferred from the possibly unsecured hardware or software environment to the smart card may be coordinates of the click or touch action where only the smart card knowing the virtual key pad geometry may easily translate these coordinates into real number and character information, e.g. the secret PIN.

According to various embodiments, the smart card may create several pictures so that not only the coordinates but also the time of the click or touch actions may be relevant.

According to various embodiments, the smart card may create or generate images in an individualized manner, so that the human user may obtain additional trust that the shown graphic is really from his/her smart card, e.g. based on a picture familiar to the human user (e.g. user-defined preferences).

According to various embodiments, security on mobile devices like Smart Phones where there may not be a technical possibility to connect a secure reader may be improved. By way of an example, a SmartPhone with NFC may be used to enable a secured communication between a contactless credit card connected via NFC to the Smart Phone so that e.g. payment transactions may not rely solely on the security of the Smart Phone hardware and operating system.

According to various embodiments, the fact that a graphic may be created inside the secure smart card may allows protected communication directly between the smart card and a human user using a regular display device like a PC without extra protection.

According to various embodiments, the smart card may create the image shown to the user in such a way that the human user can recognize the picture ideally as origin from his smart card due to certain graphical characteristics (e.g. because it is based on photography).

According to various embodiments, the image generated by the smart card may contain regions showing the human user information which he/she may confirm and regions which may serve as virtual key pad, randomly sorted, so that only the smart card can simply translate the click coordinates (and optional relative time) into an alphanumeric character (letters and numbers).

According to various embodiments, only a simple smart card reader device without pin pad nor display may be required. The smart card may receive a cryptographic message from the bank's back ground system but may create a disguised graphic with scrambled text of the transaction information and a virtual key pad, also optical disguised and buttons in random order, only easy readable by a human user.

According to various embodiments, the user may confirm the transaction by entering his/her secret PIN on the virtual key pad of a possibly unsecure hardware or software environment. The transaction may be rejected by the according button on the virtual key pad.

According to various embodiments, the possibly unsecure hardware or software environment may return the click or touch information as coordinates to the smart card which then may retrieve the clicked buttons from the coordinate information. Depending on the user action (reaction or entering correct PIN) the smart card may create a cryptographic message for the bank's back ground system. The possibly unsecure hardware or software environment, may only transfer cryptograms between the bank's background system and the smart card or handle disguised graphics and touch or click actions for the interaction between human user and smart card, but does not directly handle secret information.

A processing arrangement in accordance with one or more embodiments may include: a security element configured to generate a digital image; a display device configured to receive the digital image from the chip card, and to display the digital image; and an input device configured to receive a user input, wherein the user input may identify at least one part of the digital image, and wherein the input device may be further configured to provide the chip card with information indicating which part of the digital image is identified by the user input.

In one or more embodiments, the information indicating which part of the digital image may be identified by the user input includes spatial coordinates of a center of each part of the at least one part of the digital image identified by the user input.

In one or more embodiments, the input device may be further configured to provide the chip card with information about a time at which each part of the at least one part of the digital image may be identified by the user input.

In one or more embodiments, the information indicating which part of the digital image is identified by the user input may include a digital image of a region surrounding a center of each part of the at least one part of the digital image identified by the user input.

In one or more embodiments, the chip card may be further configured to map the information indicating which part of the digital image may be identified by the user input to at least one alphanumeric character.

In one or more embodiments, the chip card may be further configured to map the information indicating which part of the digital image may be identified by the user input to the at least one alphanumeric character using a mapping lookup table stored in the chip card.

In one or more embodiments, the chip card may be further configured to map the information indicating which part of the digital image may be identified by the user input to the at least one alphanumeric character using a mapping algorithm stored in the chip card, and executed on the chip card.

In one or more embodiments, the chip card may be further configured to generate the digital image using an image lookup table stored in the chip card.

In one or more embodiments, the chip card may be further configured to generate the digital image using at least one image generation algorithm stored in the chip card, and executed on the chip card.

In one or more embodiments, the chip card may include a memory, wherein the memory may be configured to store at least one user preference, and wherein the chip card may be further configured to generate the digital image using the at least one user preference stored in the memory.

In one or more embodiments, the at least one user preference stored in the memory may include at least one digital image provided by a user.

In one or more embodiments, the digital image may include at least one region for identification by the user input.

In one or more embodiments, the at least one region for identification by the user input may include a distorted digital image of a keypad.

In one or more embodiments, the digital image may include at least one region that shows authentic information to be confirmed by a user.

In one or more embodiments, the authentic information to be confirmed by the user may include an amount of a financial transaction.

In one or more embodiments, the authentic information to be confirmed by the user may include a destination or an origin of the financial transaction.

In one or more embodiments, the authentic information to be confirmed by the user may include a request for a confirmation of the financial transaction.

In one or more embodiments, the digital image may include at least one region that shows a request for confidential information from a user.

In one or more embodiments, the display device may include a computer screen.

In one or more embodiments, the display device may include a touch screen display.

In one or more embodiments, the input device may include a computer mouse, and wherein the user input may include a computer mouse click.

In one or more embodiments, the input device may include a touch screen display, and wherein the user input may include a touch screen input.

A method for processing information in a machine-to-human communications interface in accordance with one or more embodiments may include: generating a digital image; displaying the digital image; identifying at least one part of the digital image; and providing information indicating which part of the digital image may be identified.

While various aspects of this disclosure have been particularly shown and described with reference to these aspects of this disclosure, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

What is claimed is:

1. A processing arrangement, comprising:
a security element configured to generate a digital image;
a display device configured to receive the digital image from the chip card, and to display the digital image; and
an input device configured to receive a user input,
wherein the user input identifies at least one part of the digital image, and
wherein the input device is further configured to provide the chip card with information indicating which part of the digital image is identified by the user input.

2. The processing arrangement of claim 1, wherein the information indicating which part of the digital image is identified by the user input comprises a selection coordinate of the at least one part of the digital image identified by the user input.

3. The processing arrangement of claim 1, wherein the input device is further configured to provide the chip card with information about a time at which the at least one part of the digital image is identified by the user input.

4. The processing arrangement of claim 1, wherein the information indicating which part of the digital image is identified by the user input comprises a digital image of a region surrounding a selection coordinate of the at least one part of the digital image identified by the user input.

5. The processing arrangement of claim 1, wherein the chip card is further configured to map the information indicating which part of the digital image is identified by the user input to at least one alphanumeric character.

6. The processing arrangement of claim 5, wherein the chip card is further configured to map the information indicating which part of the digital image is identified by the user input to the at least one alphanumeric character using a mapping algorithm.

7. The processing arrangement of claim 1, wherein the chip card is further configured to generate the digital image using an image lookup table.

8. The processing arrangement of claim 1, wherein the chip card is further configured to generate the digital image using at least one image generation algorithm.

9. The processing arrangement of claim 1, wherein the chip card comprises a memory, wherein the memory is configured to store at least one user preference, and wherein the chip card is further configured to generate the digital image using the at least one user preference stored in the memory.

10. The processing arrangement of claim 9, wherein the at least one user preference stored in the memory comprises at least one digital image provided by a user.

11. The processing arrangement of claim 1, wherein the digital image comprises at least one region for identification by the user input.

12. The processing arrangement of claim 11, wherein the at least one region for identification by the user input comprises a distorted digital image of a keypad.

13. The processing arrangement of claim 1, wherein the digital image comprises at least one region that shows authentic information to be confirmed by a user.

14. The processing arrangement of claim 13, wherein the authentic information to be confirmed by the user comprises an amount of a financial transaction.

15. The processing arrangement of claim 13, wherein the authentic information to be confirmed by the user comprises at least one of a destination and an origin of the financial transaction.

16. The processing arrangement of claim 13, wherein the authentic information to be confirmed by the user comprises a request for a confirmation of the financial transaction.

17. The processing arrangement of claim 1, wherein the digital image comprises at least one region that shows a request for information from a user.

18. The processing arrangement of claim 1, wherein the display device comprises a computer screen.

19. The processing arrangement of claim 1, wherein the display device comprises a touch screen display.

20. The processing arrangement of claim 1, wherein the input device comprises a computer mouse, and wherein the user input comprises a computer mouse click.

21. The processing arrangement of claim 1, wherein the input device comprises a touch screen display, and wherein the user input comprises a touch screen input.

22. A method for processing information in a machine-to-human communications interface, comprising:
generating a digital image;
displaying the digital image;
identifying at least one part of the digital image; and
providing information indicating which part of the digital image is identified.
